(19) United States
(12) Patent Application Publication
(10) Pub. No.: US 2003/0188520 A1
(43) Pub. Date: Oct. 9, 2003

(54) Air filter system for a free-standing air blowing fan

(76) Inventor: Paul Boulva, Piedmont (CA)

Correspondence Address: OGILVY RENAULT, 1981 MCGILL COLLEGE AVENUE, SUITE 1600, MONTREAL, QC, H3A2Y3, CA

(21) Appl. No.: 10/115,907

(22) Filed: Apr. 5, 2002

(51) Int. Cl. B01D 46/00

(52) U.S. Cl. 55/467; 55/471; 55/473; 55/493

(57) ABSTRACT

A filter system for a free-standing air blowing fan having a support stand, motor driven fan blades and a cage about at least portions of the blades, is described. The filter system comprises a filter support hub defined by a solid circumferential wall. The filter support hub is secured about or forms part of the cage. The hub is also provided with filter retention attachments rearwardly thereof for removable securement of a flat annular disc-shaped air filter behind the fan blades and cage. The filter support hub has a projecting air shield front edge projecting forwardly of a central planar axis of the fan blades of the fan to prevent ingress air flow from a front opened end of the filter support hub when the fan is operating. All the ambient air is accordingly drawn from the back through the filter.

### TECHNICAL FIELD

The present invention relates to a filter system which is part of or is attachable to a free-standing air blowing fan of the type which is mounted on a stand and wherein the fan blades are motor driven. The fan blades are protected by a cage secured thereabout and the fan blades and their cage are often displaced by a motor coupling whereby to oscillate the fan and to ventilate a room.

### BACKGROUND ART

It is known to attach a filter disc on a rear portion of the cage of an air blowing fan of the type described in the present invention. For example, U.S. Pat. No. 4,477,272 teaches a disc filter which is attached to the rear portion of a fan cage by means of draw strings or hooks whereby to make the filter detachably securable. A disadvantage of such filter is that when the fan is in operation, air is drawn not only through the filter but also from about the outer periphery of the cage. Accordingly, only the air drawn through the filter is cleaned. The air entering from about the periphery of the cage is pulled through the fan blade and is mixed with the clean air. A disadvantage of this is that the air which exits the front of the fan is not totally cleaned and still contains impurities. Another disadvantage is that these impurities soil the fan blades as well as the peripheral front portion of the cage thus requiring the blades and the cage to be dismantled and cleaned from time to time. Of course, as the filter becomes dirty, there is more and more air entering the area of the fan from about the periphery of the cage and accordingly as time goes by, most of the air will not be filtered. A still further disadvantage of such filter arrangement is that the filter is totally exposed and usually placed in areas accessible to children. A child may therefore easily touch the filter which is usually filled with bacteria and transfer these to its mouth. Furthermore, such a filter arrangement is difficult to install and is visually not aesthetically pleasing to the fan structure.

U.S. Design Pat. Des. Nos. 408,513 and Des. 372,079 relate to fan filters of the type to be secured to air blowing fans and wherein the filter has a portion which extends about the circumferential side wall of the cage. However, these designs do not describe where the front edge of the cup-shaped filter terminates with respect to the fan. A disadvantage of these further dish-like filters is that they will accumulate dust around their circumferential side wall and in a short time the fan will have a displeasing appearance as the filter will become very dirty and because it extends circumferentially about a portion of the cage dust will accumulate about these portions. Also, the filter circumferential side walls could be hazardous to children who may poke their finger in the filter and contact impurities accumulated on the filter. These filters are also costly to make and difficult to clean.

U.S. Design Pat. Des. No. 359,800 shows an air filter attachment for an air blowing fan of the type described in the present application but these are mounted to the front wall of the cage. A disadvantage of these is that the fan blade and motor will become dirty very quickly by the air being pulled therethrough and arrested by the filter. Furthermore, when the front mounted filter becomes dirty, the air will have a tendency to exit the fan from about the periphery thereof making the fan inefficient and further expelling dust from around the periphery of the fan. This type of filter system is not efficient, they are also costly and difficult to install and clean. Various other types of ceiling mounted rigid filters or front mounted filters are known to clean the air or to catch insects but these have several other disadvantages as well as the ones mentioned hereinabove.

### SUMMARY OF INVENTION

It is therefore a feature of the present invention to provide a filter system for a free-standing air blowing fan and which substantially overcomes the above-mentioned disadvantages of the prior art.

Another feature of the present invention is to provide a filter system for a free-standing air blowing fan and wherein the system comprises a support hub having a filter retention means in a rear portion thereof and a projecting air shield in a front edge thereof whereby to effectively clean air which passes through the fan blades from the filter at the rear of the hub while at the same time maintaining the fan blades and the cage substantially clean requiring less frequent maintenance than known prior art air blowing fan filtering systems of the type aforementioned. The filter support hub may also be an integrated part of the cage.

Another feature of the present invention is to provide a filter system for a free-standing air blowing fan and wherein the system provides increased safety and is effective in removing dust, pollen, nicotine or cigarette smoke, microfibers and other pollutants from the air, thus improving the air quality in a room in which the fan is operating.

Another feature of the present invention is to provide a filter system for a free-standing air blowing fan which is aesthetically pleasing in design and easy to service.

Another feature of the present invention is to provide a filter system for a free-standing air blowing fan which is economical and which can serve as an effective, quiet operating, air filter thus eliminating the cost of purchasing an expensive air filtering system to substantially effect the same air cleansing. The air cleaning fan also consumes less energy and can be used on a continuous basis.

Another feature of the present invention is to provide a filter system for a free-standing air blowing fan and wherein the filters are flexible, semi-rigid, flat annular disc-like filters which have no frames, are inexpensive to fabricate, easy to clean and easy to install and wherein the filter is substantially concealed behind the fan blades in the filter assembly and which is difficult to access by children to protect them against microorganisms which may be lodged in the filter. The filter is also accessible for removal, washing, vacuum cleaning or replacement. The fan may still be used without the filter.

According to the above features, from a broad aspect, the present invention provides a filter system for a free-standing air blowing fan having a support stand, motor driven fan blades and a cage about at least portions of the blades. The filter system comprises a filter support hub defined by a circumferential wall. Means is provided to secure the filter support hub about the cage. The filter support hub has a filter retention means in a rear circumferential edge portion thereof for removable securement of a flat annular disc-shaped air filter behind the fan blades. The filter retention means may also be an independent circular frame. The filter support hub has a projecting air shield front edge projecting forwardly of a central planar axis of the fan blades of the fan to prevent ingress air flow from a front open end of the filter support hub when the fan is operating whereby air is only drawn through the filter.

According to another broad aspect, the present invention provides a filter kit comprising the hub as above-described.

### BRIEF DESCRIPTION OF DRAWINGS

A preferred embodiment of the present invention will now be described with reference to the examples thereof as illustrated in the accompanying drawings in which:

FIG. 1 is a side view of a conventional, free-standing, air blowing fan of the prior art and of the type for receiving the filter system or kit of the present invention;

FIG. 2 is a side view similar to FIG. 1 showing the disadvantages of such fans;

FIG. 3 is a side view of a free-standing air blowing fan of the type shown in FIGS. 1 and 2 but having the filter system or kit of the present invention secured to the cage thereof;

FIG. 4 is a plan view showing the flat annular disc shaped air filters utilized with the filter system of the present invention;

FIG. 5A is a partly sectioned side view of the filter system or kit of the present invention as secured to a free-standing air blowing fan and showing parts thereof in exploded view;

FIG. 5B is a top fragmented side section view of a modification of the hub of FIG. 5A;

FIG. 5C is a top fragmented side section view of a further modification of the hub of FIG. 5A;

FIG. 5D is a top view showing the connector of the hub of FIG. 5C;

FIG. 6 is a side view showing the effectiveness of the filter system or kit of the present invention when attached or connected to a free-standing air blowing fan;

FIG. 7 is a side view of a modified version of the air filter system of the present invention where the filter support is part of the fan cage;

FIG. 8 is a partly sectioned side view of the filter system and fan as illustrated in FIG. 7;

FIG. 9A is a partly sectioned view of a further embodiment of the invention where the filter support hub is also part of the fan cage;

FIG. 9B is a perspective view of the molded hub and rear cage section of FIG. 9A showing a different filter retaining means;

FIG. 10A is a partly sectioned view of another further embodiment of the invention where the filter support hub is also part of the fan cage and where the filter is located and installed inside the cage, behind the fan's blades, and maintained in position by a pressure circular frame; and

FIG. 10B is an exploded perspective view showing the removably secured molded hub and rear cage section of FIG. 10A, the flat annular disc-shaped air filter and the circular pressure filter retaining frame.

### DESCRIPTION OF PREFERRED EMBODIMENTS

Referring now to the drawings, and more particularly to FIG. 1, there is shown generally at 10 a free-standing air blowing fan as is well known in the prior art. It consists of a support stand 11 for supporting a motor 12 housed in a motor housing 13. The motor housing 13 may be rigidly secured to the stand 11 or hingedly secured on a hinge adjustable by an adjustment knob 14 to set the vertical angle of the fan. The horizontal oscillating function of the fan is set by the control knob 9. Fan blades 15 are removably secured to a motor driven shaft 16 and are attached to the shaft 16 with a mounting nut 15′ and rotate thereon. A cage 17 is secured to the front of the motor housing 13 and is usually constructed in two sections whereby the front section 17′ can be detached from the fixed rear removably secured section 17″ for cleaning the fan blades and cage. These sections are usually interconnected by clips 18.

The main purpose of these prior art fans is to displace air in a room to give a cooling effect or to displace odors or to draw air from outside through a window and introduce it into an enclosure.

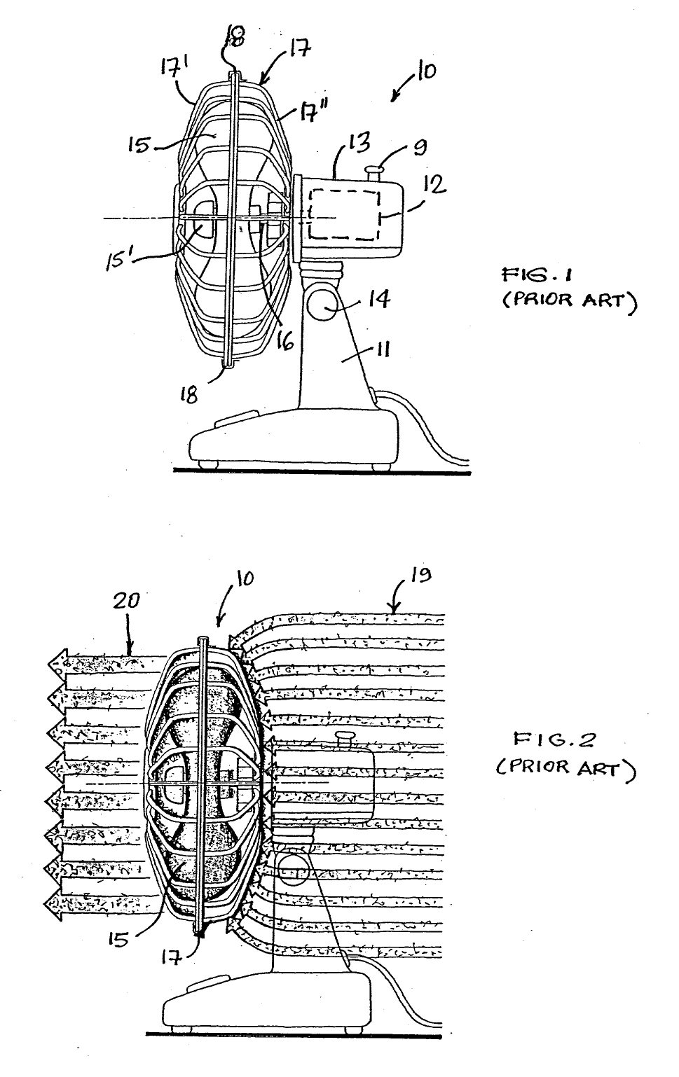

FIG. 2 illustrates a major problem of these types of air blowing fans and namely that they draw all types of pollutants and dirt present in the air and displace it in a room thereby rendering the room less sanitary than it was when the pollutants or dust had settled. Such pollutants can be particularly hazardous to people with asthmatic or allergy problems. Still further, these fans usually will circulate tobacco smoke into an environment thereby causing hazard to human. The fans also cause dust and other tarnishing particles to settle on objects or wall surfaces within a room. A still further disadvantage, as illustrated in FIG. 2, is that this dust and other pollutants will dirty the fan blade and the cage requiring more frequent dismantling and cleaning of the air blowing fan. In summary, as shown in FIG. 2, unfiltered air, as shown at 19, is drawn from the back or sides of the fan and expulsed in the front of the fan as an unclean air flow 20 while at the same time soiling the fan blades 15 and the cage 17 as well as other fan parts inside the cage.

Referring now to FIGS. 3 to 5A, there will be described the filter system or kit of the present invention for securement about the cage 17 of an air blowing fan of the type as described with reference to FIGS. 1 and 2. The filter system of the present invention comprises essentially a filter support hub 21 which defines a solid circumferential wall 22. The filter support hub is secured about the cage by securement means which will be described later. The hub 21 may be made of extruded or molded supple, semi-rigid plastics material or stamped from a metal sheet. The advantage of forming the hub in plastic is that it can flex, facilitating its installation and attachment to the fan cage.

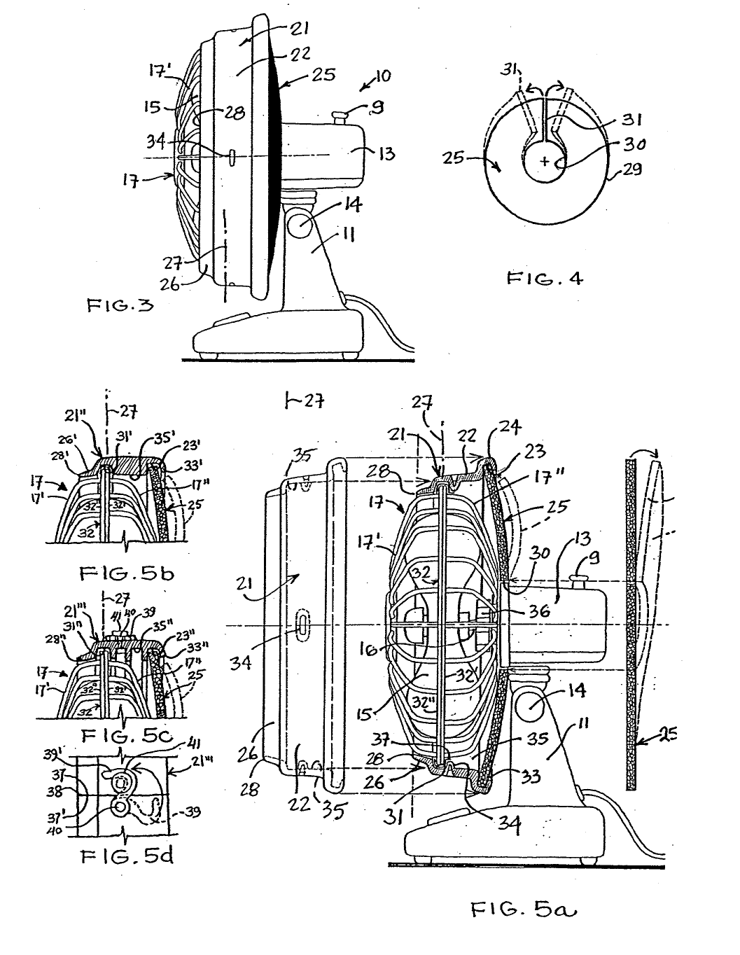

As shown in FIG. 5A, the filter support hub is also provided with a filter retention means which is herein constituted by a circumferential channel 23 formed in a rear inner circumferential edge portion 24 of the hub whereby to removably secure a flat annular disc-shaped air filter 25 as shown in FIG. 4 and positioning it rearwardly of the fan blades 15 and cage 17.

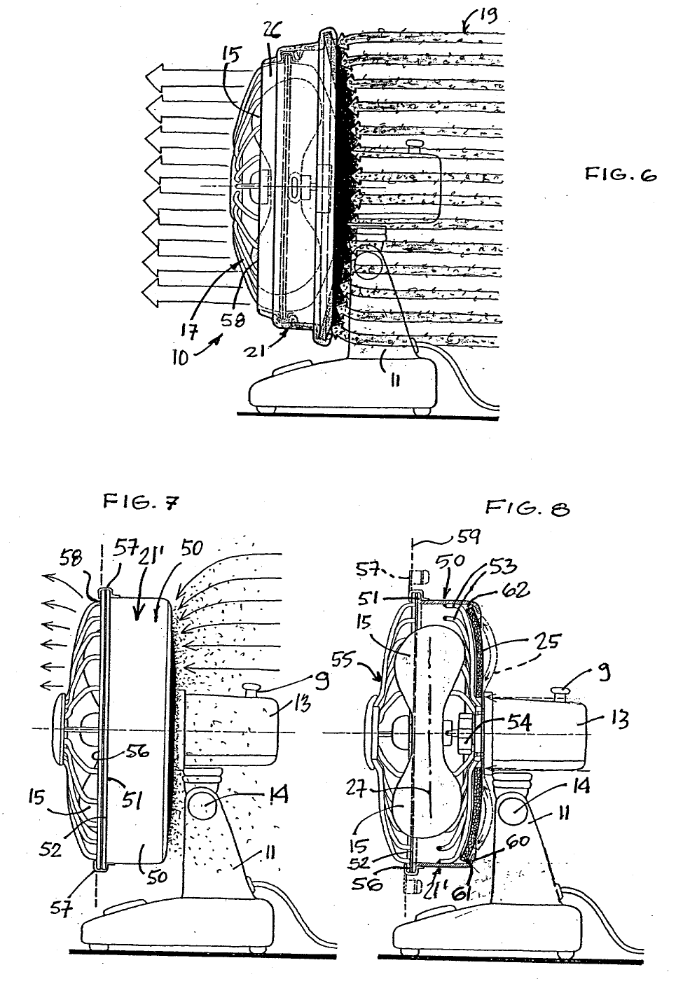

The filter support hub 21 has a projecting air shield front edge 26 which projects forwardly of the central planar axis 27 of the fan blades 15 to prevent ingress air flow from the front open end 28 of the filter support hub when the fan is operating. Accordingly, all of the air aspired by the fan is effected from the rear through the filter 25 supported rearwardly of the fan blades and therefore no air enters from the front open end 28 of the hub. The air stream exiting the front opening is substantially all cleaned filtered air and therefore the fan blade as well as the front cage portion 17′ remain substantially clean with only the filter 25 accumulating dirt thereon as illustrated in FIG. 6.

As shown in FIG. 4, the flat, semi-rigid and flexible annular disc-shaped filter 25 has a circular outer edge 29 and a circular central opening 30. The filtering material has a density which lets sufficient air therethrough not to cause the motor to force and heat up. The filter is also cleanable by a vacuum cleaner, can be removed, washed or replaced. A slotted circular, flexible, cover could also be positioned over or be part of the filter for added protection. However, this would render the filter and the fan less effective.

A slit 31 extends between the central opening and the outer edge. The diameter of the flat annular disc-shaped filter 25 is selected whereby to fit snugly within the circumferential channel 23 as shown in FIG. 5A. As shown in that Figure, the filter has a predetermined thickness to fit within the circular channel and by separating the filter along the slit 31, as shown in FIGS. 4 and 5A, it can be easily positioned about the motor housing 13 and into the circular channel 23. The circular central opening 30 is selected to fit snugly about the front portion of the motor housing 13 as shown in FIG. 5A.

Referring now again to FIG. 5A, it can be seen that the filter support hub 21 is secured about the cage in a clamping fashion by positioning a circumferential indentation or channel 31 for snapping engagement about the mating wires 32 of the cage 17 which is a wire cage constituted by a pair of disc-shaped wire shell portions 17′ and 17″ clamped together. The hub 21 is preferably a supple, semi-rigid, plastic molded hub and it is configured whereby the circumferential wall 22 slopes outwardly in at least a rear portion thereof whereby the rear circular opening 33 of the hub is greater than the front end opening 28. This permits the filter support hub 21 to be positioned over the cage 17 by front entry of the cage through the rear circular opening 33 and to snap fit it about the clamped, mating wires 32. Of course, instead of a circular indentation or channel 31, it is foreseeable that rib formations, such as the elevated rib formations 34, may be formed spaced apart along the inner surface 35 of the hub and spaced rearwardly of the projecting air shield front end 26. Accordingly, when the hub is pushed over the cage it snap-fits about the cage and this snap fit retention can be easily overcome to remove the shield by pulling outwardly on the rear edge portion 24 to disengage the ribs 32 or channel 31 from the cage. The hub could also secure the front wire shell portion 17′ to the fixed rear portion 17″.

As also shown in FIG. 5A, the rear disc-shaped wire shell portion 17″ is secured to the motor housing 13 by an attachment ring 36 which is fixedly mounted about the motor shaft 16 or the front of the motor housing 13 in an immovable position. It extends about a rear portion of the blades 15 and terminates in a circular shaped mating wire end 32′ disposed substantially on the central planar axis 27 of the fan blades 15 and spaced therearound. The forward wire shell portion 17′ also has a circular shape wire end 32″, of like diameter to the wire 32′, and these circular wires are clamped together by detachable clamps 37 to permit cleaning of the fan blades, when necessary. However, with the present invention the necessity for cleaning the fan blades is substantially less frequent than with prior art fans, as above described. It is pointed out that the circular indentation 34 or channel 31 is configured in cross section to clampingly receive the circular shape wire ends 32′ and 32″ clamped together. The circumferential wall 22 of the hub has sufficient resiliency to permit snap-engagement of the circumferential indentation about the circular shape wire ends clamped together.

FIG. 5B is a top fragmented section view of the hub 21 of FIG. 5A, this hub being identified by reference numeral 21″. As hereinshown, the hub is in the form of a closed band or gasket which is made of elastic-type material, which is also semi-rigid and flexible-like rubber. This band is provided with a groove 31′ to receive the mating wire connection 32 of the cage 17. A further groove 23′ is provided in a rear end of the band and has a depending lip 33′ whereby to retain a circumferential outer edge 29 of the filter 25 behind the rear cage section 17″. The inner face 35′ of the band is a smooth surface to achieve a smooth air-flow through the cage. The projecting air shield from edge 26′ also protrudes to a forward edge 28′ forwardly of the central planar axis 27 of the fan blades 15. An advantage of this elastic-like band or hub 21″ is that it can be installed about the cage by stretching the band as it is positioned about the wire cage mating wires 32′ and 32″ and once it is installed, it remains installed by pressure applied by the band about the mating wires 32′ and 32″. Another advantage of this type of hub is that it is easy to package due to the fact that it is deformable.

FIGS. 5C and 5D illustrate a still further version of the hub, herein identified by reference numeral 21″′. This hub, as hereinshown, is formed by an extrusion length of flexible, semi-rigid plastics material. This band is disposed about the cage 17 with its groove 31″ about the clamp mating wires 32 and the opposed ends 37 and 37′ of this band are interconnected together at 38 by a connector which is hereinshown as consisting of a hook 39 pivotally connected on a pivot pin 40 adjacent one end 37′ of the band whereby to engage a connector 41 having a peripheral groove and secured adjacent the opposed end 37 of the band. As can be appreciated, this band may have a different length to accommodate cages of different diameters and it is easy to attach about the cage. Furthermore, the front section 17′ of the cage may be secured to the fixed back section 17″ by locating the mating wires 32 within the groove 31″. The filter 25 is also securable in a like fashion as the other embodiments by locating the peripheral circumferential edge 29 of the filter into the rear groove 23″. Inner grooves 35″ are provided to form ribs to add reinforcing structure to the extruded band. It is also pointed out that various type connectors may be used to interconnect the opposed ends of the straight flexible band. Another advantage of this type of hub construction is that the band is economical to fabricate, easy to package and easy to install and can come in different lengths to adapt to cages of different diameters.

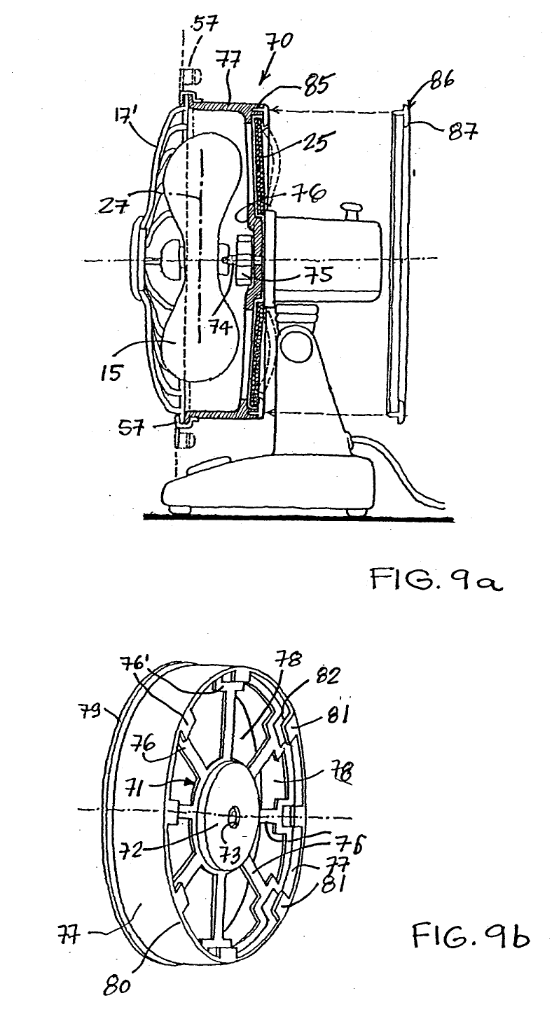

Referring now to FIGS. 7 and 8, there is shown a modification of the construction of the filter assembly of the present invention. As hereinshown, the hub 21′, which is part of or secured to rear support wire 53, has a straight solid circumferential wall 50 of circular crosssection. An attaching lip 51 projects outwardly from a front open end 52 of the hub. The hub 21′ is welded, glued or secured to rear support wires 53 connected rearwardly of the fan blades 15 and secured to an attachment ring 54. Accordingly, the wires 53 support the hub 50 concentrically about the fan blades. A front cage portion 55 is also provided with a circumferential lip 56 which mate with the lip 51 of the hub and secured in mating engagement by clamps 57. The front open end 58 of the hub assembly is disposed in a plane 59 which is forwardly of the central plane 27 of the fan blades 15.

In this embodiment, the filter retention means is defined by an inwardly projecting flange 60 formed in the rear circumferential edge portion 61 of the hub 21′ and spaced from the rear cage wires 53 a predetermined distance to form an outer circumferential gap 62 to receive an outer circumferential edge of the air filter 25.

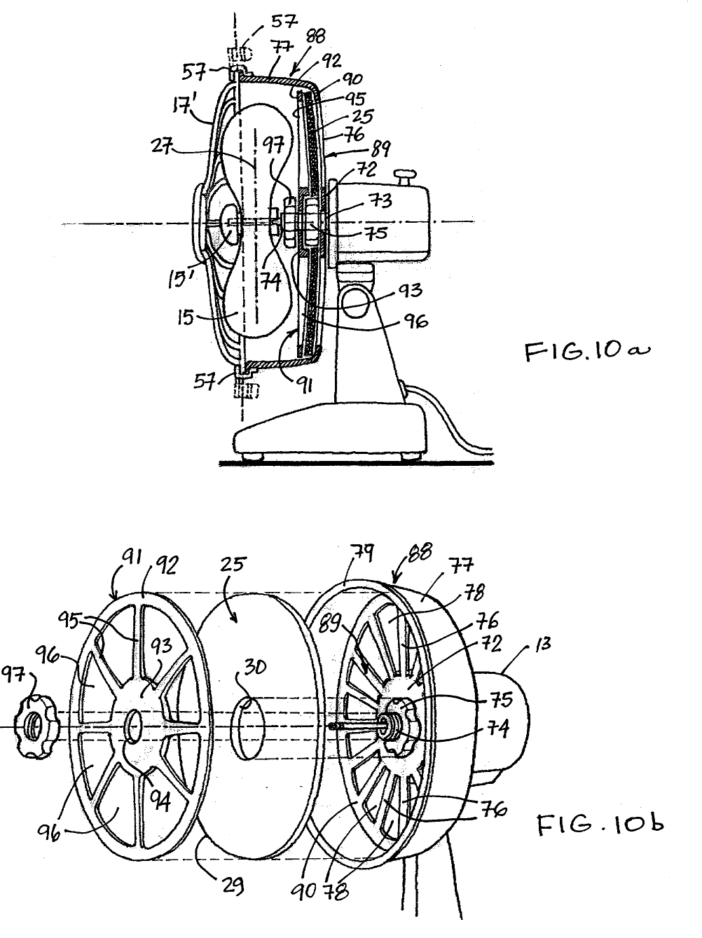

Referring now to FIG. 9A, there is shown a still further embodiment of the construction of the filter assembly of the present invention. As hereinshown, the hub 70 is provided with a support rear wall structure 71, as shown in FIG. 9B, which constitutes the rear cage portion and accordingly the rear cage wire portion 17″ is not necessary. The rear wall structure 71 is formed with a central connecting disc 72 having a hole 73 therein to mount the hub about the shaft 74 and to secure it thereto by the nut 75.

Radiating ribs 76 extend from the central connecting disc 72 to the rear edge of the hub circumferential side wall 77 and define large openings 78 therebetween to permit air flow through the fan blades 15. The hub 70 is further provided with a circumferential front connecting flange 79 whereby to secure the front cage section 17′ to the circumferential front edge of the circumferential side wall 77 by clamps 57 as previously described.

As shown in FIG. 9B, the radiating ribs 76 are recessed from the rear edge 80 of the circumferential side wall 77 whereby tabs 81 may be formed about the rear edge and spaced from an enlarged end section 76′ of the ribs to constitute retention slots 82 between the tabs 81 and the enlarged portion 76′ to receive and retain the circumferential outer circular edge 29 of the disc filter 25 as shown in FIG. 4.

FIG. 9A shows a different embodiment of the filter retention means. As hereinshown, the rear edge of the circumferential side wall may be formed with a circumferential slot 85 whereby to retain captive therein a detachable connecting ring 86 which is provided with a filter retention flange 87 to retain the peripheral edge portion of the disc filter 25 behind the ribs 76 covering the openings 78. Accordingly, in both the filter retention means as shown in FIGS. 9A and 9B, the filter is easy to install and remove from the hub for cleaning purposes. Also, with this embodiment, it is also easy to dismantle the front cage from the hub providing access to the hub about the fan for ease of cleaning. The circumferential side wall 77 of the hub is also dimensioned whereby its front edge extends forwardly of the central planar axis 27 of the fan blades 15 to prevent ingress air flow from the front open end of the filter support hub whereby air is only drawn through the filter 25.

Referring now to FIGS. 10A and 10B, there is shown a still further embodiment of the filter assembly of the present invention. As hereinshown, the hub 88 is provided with a relatively flat support rear wall structure 89, which constitutes the rear cage portion similar to that shown in FIGS. 9A and 9B. The rear wall structure 89 is formed with a central connecting disc 72 having a central hole 73 therein to mount the hub about the shaft 74 and to secure it thereto by the nut 75.

Radiating ribs 76 extend from the central connecting disc 72 to the rear filter abutment circular flange 90 projecting inwardly from the rear edge of the hub circumferential side wall 77 and define openings 78 therebetween to permit air flow through the fan blades 15. The hub 88 is further provided with a circumferential front connecting flange 79 whereby to secure the front cage section 17′ to the circumferential front edge of the circumferential side wall 77 by clamps 57, as previously described.

The disc filter 25, has an equal or slightly smaller diameter than the rear inside diameter of the hub 88, and a center hole 30, having an equal or slightly bigger diameter than the diameter of the mounting nut 75, is positioned forwardly inside the hub 88 against the hub support rear wall structure 89 and is held in place by a pressure filter retaining perforated disc frame 91 also removably-secured by a nut 97 on the same threaded shaft 74 retaining the hub 88.

The relatively thin filter retaining disc frame 91 can be molded from a sturdy but supple plastic material. As shown in both FIGS. 10A and 10B, the filter retaining disc 91, which has an outer diameter slightly smaller than the rear inside diameter of the hub 88 and a center hole 94 having a slightly bigger diameter than the mounting shaft 74, has an outer circumferential wall 92 and radiating ribs 95 extending from the central connecting disc 93, and defines large openings 96 therebetween to permit air flow through the filter 25 and fan blades.

The filter retaining disc 91 is positioned on top of the filter 25 and maintained in position with pressure on the filter using the nut 97. Because the inside diameter of the hub rear flange 90 and the inside diameter of the circumferential wall 92 of the retaining disc 91 are smaller than the outside diameter 29 of the filter 25, and because the outer diameters of the hub connecting disc 72 and of the filter retaining disc central connecting disc 93 are larger than the diameter of the filter centre hole 30, all the air is drawn through the filter 25.

It is notable that with this embodiment the mounting nut 97 could be molded integrally with the filter retaining frame 91 to form one unique component. The disc filter has no slit and could be dye-cut or stamped from very thin fiber material. The pressure type filter retaining means helps eliminate vibrations and noise and the filter may be cleaned easily from the back of the hub's grid with a vacuum cleaner eliminating most of the dust accumulated in the filter without having to remove the filter from the cage

It is within the ambit of the present invention to cover any other obvious modifications of the preferred embodiment described herein, provided such modifications fall within the scope of the appended claims.

1. A filter system for a free-standing air blowing fan having a support stand, motor driven fan blades and a cage supported about at least portions of said blades, said system comprising a filter support hub defined by a circumferential wall, said filter support hub and said cage being connected together, filter retention means associated with said filter support hub for removable securement of a flat annular disc-shaped air filter behind of said fan blades, said filter support hub having a projecting air shield front edge projecting forwardly of a central planar axis of said fan blades of said fan to prevent ingress air flow from a front open end of said filter support hub when said fan is operating whereby air is only drawn through the filter.

2. A filter system for a free-standing air blowing fan as claimed in claim 1 wherein said filter support hub is connected about said cage by securing means.

3. A filter system for an air blowing fan as claimed in claim 2 wherein said filter retention means is a circumferential channel formed in an inner surface of said filter support hub adjacent a rear edge of said hub.

4. A filter system for an air blowing fan as claimed in claim 3 wherein said flat annular disc-shaped filter has a circumferential outer edge, a circular central opening, and a slit between said central opening and said outer edge.

5. A filter system for an air blowing fan as claimed in claim 2 wherein said securing means to secure said filter support hub about said cage comprises inner clamp means for clampingly retaining said filter support hub to said cage.

6. A filter system for an air blowing fan as claimed in claim 5 wherein said filter support hub is a plastic molded hub, said circumferential wall sloping outwardly in at least a rear portion thereof whereby the diameter of a rear circular opening of said hub is greater than the diameter of a front opening thereof to permit said filter support hub to be positioned over said cage by front entry of said cage through said rear circular opening of said hub.

7. A filter system for an air blowing fan as claimed in claim 6 wherein said clamp means is a circumferential indentation formed in an inner surface of said filter support hub spaced rearwardly of said projecting air shield, said circumferential indentation being configured for snap-fit engagement about a circumferential outer portion of said cage.

8. A filter system for an air blowing fan as claimed in claim 7 wherein said cage is a wire cage formed by two disc-shaped wire shell portions, a rear one of said wire shell portions being secured rearwardly of said fan blades and extending about a rear portion of said blades and terminating in a circular shape mating wire end disposed substantially on said central planar axis of said fan blades and spaced therearound, a forward one of said wire shell portion also having a circular shape wire end of like diameter to that of said rear wire shell, said circular shape wire ends being clamped together by detachable clamps to permit cleaning of said fan blades, said indentation being configured to clampingly receive said circular shape wire ends clamped together when said filter support hub is pushed over said wire cage from said rear circular opening thereof, said circumferential wall having sufficient resiliency to permit snap-engagement of said circumferential indentation about said circular shape wire ends clamped together.

9. A filter system for an air blowing fan as claimed in claim 6 wherein said clamp means is constituted by abutment rib formations formed in said inner surface of said filter support hub rearwardly of said projecting air shield, said projecting air shield extending in close fit relationship about said cage.

10. A filter system for an air blowing fan as claimed in claim 2 wherein said cage has a rear cage portion secured behind said fan blades, said filter support hub being secured about said rear cage portion, and a front cage portion secured about a front open end of said filter support hub, said front open end being disposed in a plane parallel and forward of said central planar axis of said fan blades.

11. A filter system for an air blowing fan as claimed in claim 10 wherein said filter retention means is defined by an inwardly projecting flange formed in said rear circumferential edge portion of said hub and spaced from said rear cage portion and a predetermined distance to form an outer circumferential gap to receive an outer circumferential edge of said air filter.

12. A filter system for an air blowing fan as claimed in claim 2 wherein said filter support hub is formed by an extruded band of flexible, semi-rigid, plastic material having opposed ends, a connector for interconnecting said opposed ends together with said band positioned about said cage.

13. A filter system for an air blowing fan as claimed in claim 12 wherein said band is provided with a cage engaging channel in an inner surface thereof and spaced a predetermined distance from said air shield front edge to engage over a circumferential protrusion about said cage.

14. A filter system for an air blowing fan as claimed in claim 2 wherein said filter support hub is formed as a deformable circular ring of rubber-like material, said ring having a cage engaging means in an inner surface thereof and spaced a predetermined distance from said air shield front edge to engage over a circumferential protrusion about said cage.

15. A filter system for an air blowing fan as claimed in claim 2 wherein said hub is constituted by a flat ring of plastics material, said flat ring having an integrally formed rear cage section constituted by radiating ribs extending from a rear edge portion of said ring to a central connecting rear disc removably secured to a motor housing associated with said support stand, air inlet openings between said ribs, and means to connect a front cage section to said air shield front edge of said ring.

16. A filter system for an air blowing fan as claimed in claim 15 wherein said filter retention means is constituted by slot formations depending from said rear edge portion of said ring to receive peripheral outer edge portions of said flat annular disc-shaped filter.

17. A filter system for an air blowing fan as claimed in claim 15 wherein said filter retention means is construed by a detachable connecting ring removably secured about said rear edge portion of said flat ring.

18. A filter system for an air blowing fan as claimed in claim 1 wherein said filter retention means is constituted by a perforated hub support rear wall structure extending from a rear edge of said circumferential wall of said filter support hub to a central connecting disc securable about a drive shaft of said fan blades, and a perforated disc frame also securable to said drive shaft forwardly of an inner face of said hub support rear wall structure for retaining said filter in tight fit between said perforated hub support rear wall structure and said perforated disc frame.

19. A filter system for an air blowing fan as claimed in claim 18 wherein said filter support hub circumferential wall and said hub support rear wall structure are integrally formed from plastics material, said rear wall structure being defined by a top circumferential flat flange projecting inwardly from said rear edge of said hub circumferential wall spaced apart flat radiating ribs extending from said central connecting disc to said flat flange, and holes defined between said radiating ribs for the passage of air.

20. A filter system for an air blowing fan as claimed in claim 19 wherein said central connecting disc has a central hole for receiving said drive shaft therethrough, and a threaded connecting nut for connecting said connecting disc to said shaft.

21. A filter system for an air blowing fan as claimed in claim 18 wherein said perforated disc frame is a rigid frame also secured to said drive shaft by a threaded connecting nut to apply pressure on said disc-shaped air filter, said filter being held captive against said top circumferential flat flange, said flat ribs and an outer portion of said central connecting disc of said perforated hub support.

22. A filter system for an air blowing fan as claimed in claim 21 wherein said perforated disc frame is a plastic molded frame defining an outer circumferential narrow wall, a plurality of flat radiating ribs extending from said outer circumferential narrow wall to a central connecting disc, a central hole in said connecting disc for receiving said drive shaft therethrough, said filter having a central hole which is smaller in diameter than an outer diameter of said central connecting disc of said hub support rear wall structure and said perforated disc frame said filter having an outer diameter which is larger than the inner diameter of said circumferential narrow wall of said perforated disc frame and than the inner diameter of said circumferential flat flange of said filter support hub.
